(19) United States
(12) Patent Application Publication
(10) Pub. No.: US 2012/0308683 A1
(43) Pub. Date: Dec. 6, 2012

(54) DOUGH COMPOSITIONS AND RELATED METHODS INVOLVING HIGH-GLUTEN CONTENT

(76) Inventors: Jeffrey L. Casper, Minneapolis, MN (US); Alan A. Oppenheimer, Savage, MN (US); Braden J. Erickson, Eden Prairie, MN (US); Madonna M. Ray, Vadnais Heights, MN (US); Jean L. Weber, Plymouth, MN (US)

(21) Appl. No.: 13/563,098

(22) Filed: Jul. 31, 2012

Related U.S. Application Data
(62) Division of application No. 11/249,558, filed on Oct. 13, 2005.
(60) Provisional application No. 60/618,614, filed on Oct. 14, 2004.

(51) Int. Cl. A21D 8/04; A21D 8/06; A21D 15/02

(52) U.S. Cl. 426/19

(57) ABSTRACT

Described are dough compositions and related methods that involve the use of a preferment or sponge dough, and wherein the preferment or sponge dough composition includes a concentrated protein ingredient, optionally to produce an unproofed dough composition that can be baked without proofing.

### PRIORITY CLAIM

The present non-provisional patent application claims the benefit of priority under 35 USC 119 from commonly owned U.S. Provisional Patent Application having Ser. No. 60/618,614, filed on Oct. 14, 2004, in the name of Casper et al., and titled DOUGH COMPOSITIONS AND RELATED METHODS, INVOLVING HIGH-GLUTEN CONTENT, which patent application is incorporated herein by reference in its entirety.

### FIELD OF THE INVENTION

This invention relates to dough compositions and methods related to the use of a preferment dough composition, e.g., sponge.

### BACKGROUND

Dough products are prepared by combining ingredients including yeast, water, and flour, among others. One method by which these ingredients can be combined to produce a dough is by a two-step method according to which a dough “preferment” dough composition is first prepared to include a portion of total dough ingredients, and the balance of the total dough ingredients is later added after a certain amount of processing (e.g., “resting”) of the preferment composition.

The preferment is first prepared by combining ingredients thereof. The preferment composition is then allowed a time to rest, during which time yeast will ferment and the ingredients of the dough will develop. After resting, additional dough ingredients are added to form a finished, unproofed dough composition. Generally, yeast is again allowed to ferment in a “proofing” step, which leavens the finished dough composition before cooking. Upon cooking, the proofed dough will exhibit a recognizable flavor and aroma of a fresh-baked yeast-leavened dough product, as well as a light (leavened) composition.

In the dough and bread-making arts there is ongoing need for new and useful dough compositions, e.g., that exhibit usefulness based on product quality, cost efficiency, or convenience. In one specific respect, consumers desire convenience of use. Dough compositions that can be stored for extended periods of time, and used at will, are appreciated by consumers. Also appreciated are dough products that do not require a substantial amount of time or effort to prepare following removal from storage. In this respect, certain types of dough products that may be particularly favored by consumers are those that can be prepared without a time-consuming proofing step. For example, such a dough composition may be removed from refrigerated or frozen storage and placed into an oven for baking, without a thawing step, without a proofing step, or without either.

### SUMMARY

The invention relates to dough compositions, including certain un-finished (e.g., in-process) and finished dough compositions, as well as processes relating to such dough compositions, including processes that involve preparing a “preferment” dough composition. According to the invention, the preferment dough composition contains an ingredient referred to as a concentrated protein ingredient, which is a non-flour ingredient that contains a concentrated amount of a protein, such as a gluten protein or gluten mimetic. Including a concentrated protein ingredient in a preferment composition allows for useful and desirable properties of a finished dough composition prepared from the preferment composition, including useful leavening properties, as are described herein.

Standard or well-known flour-based dough systems produce a cooked dough product having a cellular structure that results from gas bubbles (or “cells”) formed within a dough matrix while dough ingredients are mixed together. According to certain methods that involve the use of a “preferment” (e.g., “sponge”) dough composition, a step of preparing a preferment composition results in the production of nucleation sites in the preferment composition, and also produces carbon dioxide that will eventually cause the nucleation sites to expand into bubbles and cause the dough to leaven to an expected structure and texture. The bubbles ultimately give rise to the cellular structure observed in the cooked dough product. The distribution of the bubbles and the ability of the bubbles within the matrix to hold gas influence the volume of a baked dough product, and whether or not a baked dough product will exhibit the expected light and cellular texture of a baked dough product. Another influence of cooked dough qualities can be the amount of expansion and ultimate size of bubbles produced during baking, which can depend on factors such as the amount of gas contained in a bubble or absorbed in the dough composition, and mechanical and rheological properties of a dough matrix such as strength and elasticity.

A preferment dough composition can be used to produce gas bubbles in a dough composition, and also to produce the carbon dioxide that will eventually cause the bubbles to expand and leaven the dough during cooking (e.g., baking). To that end, an ingredient of a typical preferment dough composition is a wheat flour that contains an amount of the protein gluten. Gluten can be responsible for properties such as mechanical properties of a dough matrix that allow the dough to be processed to contain bubbles, and that allow the matrix to stretch and expand during baking. For instance, gluten provides the dough matrix with strength to trap and hold gas in the form of bubbles, during preparation of the preferment and also when additional ingredients are added to the preferment. Still, in such a flour-based preferment composition, the portion of bubbles retained upon combining the preferment composition with additional dough ingredients, by mixing, can be limited by the level of gluten contained in the wheat flour. Also, the amount of carbon dioxide retained during mixing in additional dough ingredients may be limited in part by the level gluten present in the wheat flour. Thus, the level of expansion that occurs during baking of a dough composition prepared by a preferment composition based on wheat flour, generally does not exceed twice the volume of the raw dough going into the oven.

According to the invention, a preferment dough composition is prepared to include a relatively high amount of a concentrated protein such as gluten, by inclusion of an added, non-wheat-flour ingredient that includes a concentrated level of a useful protein. The high protein preferment system can produce improved expansion during baking relative to doughs made without adding such a concentrated protein ingredient to the preferment composition. The added protein can provide a strengthened dough matrix that is capable of trapping a relatively high amount of carbon dioxide, and may optionally provide a greater number of gas cells or bubbles in a dough matrix upon combining the preferment dough composition with additional ingredients by mixing.

Without being bound by theory, it is possible that a concentrated protein ingredient in a preferment sponge improves leavening during baking by one or more mechanisms. According to one possible mechanism, hydration and development of the amount of increased protein in the dough matrix begins relatively early, during the mixing of the preferment system, when the protein (e.g., gluten) is present in the dough composition in the absence of the remaining dough constituents that would compete for the water. The result is a hydrated protein matrix, including the extra protein of the concentrated protein ingredient, which is capable of entrapping carbon dioxide produced by the yeast during the fermentation hold time.

According to a second possible mechanism, the improved strength and elasticity of a preferment dough matrix that contains an increased concentration of protein (e.g., gluten) can result in a relatively higher amount of gas cell nucleation sites being entrained in the dough upon mixing to combine the preferment with additional dough ingredients, after which there is no further opportunity for additional gas cell-nuclei to be produced.

Thus, the present invention involves a dough composition that includes a preferment portion that includes a concentrated protein ingredient, e.g., a concentrated gluten ingredient, to provide a preferment dough composition that contains relatively high amount of protein compared to other preferment dough compositions. The use of a preferment generally can produce carbon dioxide and other gases or water vapor, in a cellular dough structure. Inclusion of a concentrated protein ingredient in the preferment composition results in a dough matrix having mechanical properties that improve the gas-holding capacity of the dough matrix, such as good strength, flexibility-, elasticity-, and -extensibility. The combination can result in a greater amount of overall expansion of the dough composition during cooking (e.g., baking), and consequently a higher baked specific volume.

Advantageously, dough compositions of the invention can exhibit specifically useful leavening properties. Exemplary baked specific volumes achieved by baking an unproofed dough composition from the frozen state, may exceed 3 cubic centimeters per gram (cc/g), e.g., greater than 4, 4.5, or 5 cc/g, or more. According to specific embodiments of dough compositions of the invention, a dough composition can be cooked, e.g., baked, from an unproofed state, to a specific volume that is greater than dough compositions made without the use of the described preferment that contains a concentrated protein ingredient. More specifically, examples of dough compositions of the invention prepared from a preferment composition that contains a concentrated protein ingredient as described herein, can be baked from an unproofed state, directly, without proofing, to produce a baked dough product that has a specific volume that is comparable to dough compositions that are otherwise similar but that are proofed prior to baking. Examples of such embodiments of the invention can exhibit leavening properties that result in expansion of the dough composition from a raw unproofed state, to a volume that is at least or that is greater than 3.5 to 4.0 times the original unproofed volume e.g., at least 4.5 times initial unproofed volume, while still achieving other desired bread-like properties such as color texture, taste, and aroma.

A raw dough composition of the invention can be baked directly (immediately or soon after it is formed to a dough piece) or can be formed to a dough piece and then stored at frozen or refrigerated conditions, then baked from storage without a proofing step. Specific embodiments can be stored unproofed and frozen and baked directly from frozen storage without a proofing or a thawing step. More generally dough compositions of the invention may include any of various general classes of dough compositions, such as refrigerated doughs, frozen doughs, varieties of developed doughs, freezer-to-oven doughs, retarder-to-oven doughs, etc. According to certain embodiments, the inventive dough compositions and methods can be used with developed, freezer-to-oven dough compositions and related methods. Examples of specific types of dough products or dough pieces include but are not limited to types of doughs sometimes prepared by using a preferment method, including bread, breadsticks, boules, baguettes, rolls, buns, pizza crusts, flatbreads, fococcia, bagels, pretzels, croissants, and the like.

Commercial importance of unproofed, oven-ready doughs (e.g., freezer-to-oven dough composition) is considerable. For example, costs of shipping an unproofed versus a proof dough product are reduced due to the low initial volume of the product. This translates into less space required for storage by a customer. Current customer requirements for many frozen dough products can include proofing before baking. Proofing can require an extended preparation time by a user, as well as possibly well-trained employees and expensive space and equipment. Additionally, the time requirements of proofing and thawing steps, as compared to the prospective ease in using an unproofed freezer-to-oven dough, make freezer-to-oven doughs an attractive concept.

According to the present description, unless otherwise indicated, percentages are in terms of the total weight of a dough composition, e.g., a preferment dough composition or a finished dough composition that includes the preferment dough composition plus all ingredients added to the preferment dough composition, including flour.

In the present description, the term “unproofed” is used as generally understood in the dough and baking arts, e.g., to refer to a dough composition that has not been processed to include timing intended to cause or allow proofing or intentional leavening of a final dough composition; a resting step of a preferment dough composition is not considered to be a proofing step. For example, a final dough composition may not have been subjected to a specific holding stage for causing the volume of the dough to increase by more than 10 percent.

An aspect of the invention relates to a high-protein preferment dough composition. The high-protein preferment dough composition includes water, yeast, yeast nutrient, and concentrated protein ingredient.

Another aspect of the invention relates to a dough composition that includes a high-protein preferment dough composition. The high-protein preferment dough composition includes water, yeast, yeast food, and concentrated protein ingredient. The dough composition includes the high-protein preferment composition, and additional dough ingredients that include flour and additional water.

Yet another aspect of the invention relates to a method of preparing a dough composition. The method includes preparing a high-gluten preferment dough composition comprising water, yeast, yeast food, and concentrated protein ingredient; resting the preferment dough composition, and combining the preferment dough composition with additional dough ingredients that include flour and water.

### BRIEF DESCRIPTION OF THE DRAWINGS

FIG. 1 is an example of a graphical analysis of high temperature viscosity of certain starch materials.

### DETAILED DESCRIPTION

Doughs of the invention are doughs that include a preferment dough composition, and additional dough ingredients, e.g., dough prepared by what is sometimes referred to as a “preferment” method. In general, steps of preparing such a dough composition can include first, preparation of a “preferment” dough composition, a step that allows yeast of the preferment composition to ferment, followed by a step of combining the preferment composition with additional dough ingredients to produce a finished or final dough composition. The preferment dough composition includes a dough matrix having bubbles that can include gas and water vapor that will be maintained when forming a finished dough composition, and that will contribute to expansion (leavening) of the finished dough composition upon cooking (e.g., baking). Examples of preferment dough compositions according to the invention can be similar to dough compositions sometimes referred to as a dough “sponge” or a “poolish.”

According to the invention, the preferment dough composition includes a concentrated protein ingredient to strengthen the dough matrix of the preferment dough composition, which will in turn strengthen the matrix of a finished dough composition and allow the finished dough matrix to experience greater expansion during cooking and to exhibit a relatively high specific volume upon cooking. For instance, a concentrated protein ingredient (e.g., a concentrated gluten ingredient) in the preferment composition can provide a dough matrix having mechanical properties of increased elasticity and extensibility and increased overall gas-holding capacity.

A “concentrated protein ingredient” as used according to the present description includes a non-wheat-flour ingredient that contains a substantial concentration of gluten or another protein that provides improved gas holding capacity to a developed dough. Non-gluten proteins that may be useful in a concentrated protein ingredient may include proteins such as albumen; casein, casienates; milk proteins such as whey protein, modified whey protein; soy protein; modified soy protein; legume proteins, protein isolates; and the like, any of which may be used alone or in combination with gluten. The concentrated protein ingredient can be a non-wheat-flour ingredient, known or developed in the future, that includes such a useful protein in a concentration effective to improve gas-holding, capacity of the dough matrix as described herein. Certain concentrated gluten ingredients can include gluten at a concentration of at least 20 weight percent gluten based on the total weight of the gluten ingredient, e.g., at least 75 weight percent gluten based on total weight of the gluten ingredient. While dough compositions of the invention include wheat flour, and wheat flours can include gluten, standard wheat flours (including high gluten wheat flour) often used in dough compositions prepared by a preferment method, are not considered concentrated protein or “gluten ingredients” for purposes of this description. Still, the total amount of protein, or the total amount of gluten in a dough composition can include an amount of gluten that is part of a gluten ingredient or a concentrated protein ingredient, in combination with any amount of protein or gluten that is present due to a wheat flour ingredient (e.g., a high gluten flour).

Vital wheat gluten is an example of a concentrated protein ingredient (here, a “concentrated gluten ingredient”), and normally is an ingredient in the form of a protein powder having the ability to reconstitute rapidly in water to give a homogenous, viscoelastic, coherent mass with similar properties as the native flour protein would possess when washed out in the form of wet gluten. Starch and bran normally present in a wheat flour have been removed from this ingredient. The typical commercial vital wheat gluten ingredient can contain from 75 to 80 percent by weight total protein (of which about 80 percent is gluten in the form of either glutenin or gliadin) 10 percent by weight residual starch, and 5 percent by weight lipid (all dry weight basis), with the remainder being minerals, fiber, and other impurities. Moisture content is typically from 8 to 9 percent based on weight, not normally in excess of 10 percent by weight.

Gluten can exist in at least two forms, including glutenin and gliadin. Glutenin can be defined as gluten that is insoluble in 70 percent aqueous alcohol (e.g., MeOH, EtOH). Gliadin can be defined as gluten that is soluble in 70% alcohol. According to certain specific embodiments of the invention, a concentrated gluten ingredient can contain a preponderance or more of glutenin, which is believed to have particularly good effects on the mechanical properties of a dough matrix, e.g., between 50 and 80 percent glutenin, and 20 to 50 percent gliadin, based on total gluten.

According to the invention, a concentrated protein ingredient can be included as an amount of a preferment dough composition to provide described mechanical properties of the preferment composition, and desired leavening properties of the finished dough composition. Examples of useful amounts of a concentrated gluten ingredient (e.g., vital wheat gluten) having from 70 to 80 percent by weight protein, that can be included in a preferment composition, may be in the range from 6 to 40 percent by weight gluten ingredient based on total weight of a preferment sponge, e.g., from 15 to 25 weight percent gluten ingredient based on total weight of a sponge.

A concentrated protein ingredient can be included in a preferment dough composition in an amount that provides an amount of total protein in the preferment dough composition to provide desired mechanical, rheological, gas-holding, and leavening properties in a preferment or a final dough composition, as described herein.

According to certain specific embodiments of the invention, a total amount of protein in a preferment dough composition, based on any protein found in a flour ingredient or in a non-flour concentrated protein ingredient (e.g., vital wheat gluten, etc.) can be in the range from 12 to 35 weight percent, e.g., from 15 to 25 weight percent protein (based, e.g., on 16% gluten flour (high gluten flour), and a preferment that is 7% flour. Based on a total dough formulation, a preferment dough composition can include sufficient concentrated protein ingredient to produce a finished dough composition that contains, e.g., in the range from 10 to 18 weight percent total protein (of which 5 to 25 weight percent of the total protein may be gluten) based on the total weight of the dough composition.

The preferment composition can generally include ingredients, in addition to the concentrated protein ingredient, useful to provide a preferment dough composition having an extensible sponge matrix. Examples of such ingredients include yeast, water, a yeast food or nutrient, and optionally flour. The yeast becomes metabolically active during steps of preparing or resting the preferment composition, and produces carbon dioxide and other metabolites that diffuse to nucleation sites, which then form bubbles in the matrix. The carbon dioxide and other metabolites can also become absorbed by, optionally to a point of saturating, an aqueous component of the preferment composition. The preferment composition takes the form of a dough matrix being interrupted by a large amount of bubbles (or “cells”) containing carbon dioxide and water vapor. Thus, a preferment dough composition of the invention can be prepared by combining ingredients including at least yeast, water, a yeast nutrient, concentrated protein ingredient, and optionally flour. These ingredients can be combined in any acceptable manner to produce a preferment dough composition.

Flour can be included in the preferment composition, but is optional, and if desired or useful can be excluded from the preferment dough composition and added in an entire amount (for a particular finished dough composition) to the preferment dough composition after resting. According to certain specific embodiments of methods and dough compositions, the invention allows for all or some of an amount of flour that may otherwise by included in a preferment dough composition, to be replaced by a concentrated protein ingredient (e.g., a concentrated gluten ingredient). As noted, an amount of flour may subsequently be combined with the rested or prefermented dough composition, along with other additional dough ingredients.

A flour included in a preferment composition, if used, can be any suitable flour or combination of flours, such as wheat flour that may be hard wheat winter or spring flour. Such a flour may contain any desired or useful amount of protein such as an amount in the range from about 10 weight percent to about 16 weight percent protein based on the weight of the flour. A high protein flour (containing between about 12 and about 16 weight percent protein) may be useful.

If flour is included, a preferment composition can include an amount of flour effective to provide desired structure and consistency, e.g., structure and consistency that allow for fermentation of yeast, expansion of the preferment composition, and formation of bubbles. Such useful amounts are generally known in the dough and bread making arts. Exemplary amounts of total flour in a preferment composition can be in the range from 2 to 45 weight percent flour based on the total weight of a preferment, e.g., from 8 to 12 weight percent flour based on the weight of the preferment dough composition.

Yeast is included in the preferment composition to produce metabolites, especially gaseous metabolites such as carbon dioxide. The amount of yeast included in the preferment dough composition can be an amount that will produce a desired volume of metabolic products (e.g., carbon dioxide) to in turn cause the preferment dough composition to produce and expand nucleation sites into bubbles and to develop and strengthen, optionally an amount sufficient to also cause carbon dioxide to be absorbed by water in the preferment dough composition, even to produce a water component that is saturated with absorbed carbon dioxide.

Yeast can be in the form of a yeast ingredient such as any one or more of those sometimes referred to as fresh crumbled yeast (also called cake yeast or compressed yeast); yeast cream; a dry yeast such as instant dry yeast, dry active yeast, protected active dry yeast; frozen yeast; and combinations of these. Yeast ingredients such as these can differ in the amount of moisture they contain, which can in turn influence how much of a particular yeast ingredient should be included in a preferment or a final dough composition. For example, some yeast ingredients have a high moisture content (e.g., greater than 60% by weight). These high moisture yeast ingredients include those yeast ingredients sometimes referred to as fresh crumbled yeast, cake yeast, compressed yeast, and yeast cream. Other yeast ingredients can include lower amounts of moisture, e.g., less than 10 percent by weight moisture (generally 2 to 8 weight percent moisture), and include yeast ingredients sometimes designated “dry” yeast ingredients, e.g., active dry yeast and instant dry yeast.

The moisture content of a yeast ingredient can affect the total amount of a yeast ingredient included in a dough composition. Fresh crumbled yeast, cake yeast, and compressed yeast can typically have a moisture content of about 70 percent moisture per total weight of the yeast ingredient. Yeast creams typically have a higher moisture content, and dry yeast ingredients such as dry active yeasts typically have a lower moisture content, e.g., typically about 7 or 8 percent moisture per total weight of the yeast ingredient. Thus, due to differences in moisture content, different amounts of a dry yeast ingredient (including water in a lower amount) would be needed compared to higher moisture content yeast ingredient such as fresh crumbled yeast, cake yeast, or compressed yeast. (The term “yeast ingredient,” e.g., when used to describe amounts of yeast in a dough composition, is used herein to refer to yeast in a form that includes the moisture content of the yeast ingredient.)

Exemplary amounts of compressed yeast that can be included in a preferment dough composition in accordance with the invention can be amounts within the range from 2 to 20 weight percent, e.g., from 8 to 12 weight percent compressed yeast ingredient (including the water component of the ingredient), based on a total weight of a preferment composition. Other yeast ingredients that have similar moisture content can be used in these same ranges. Yeast ingredients that have different (higher or lower) percent moisture can be used as an early stage yeast portion in higher or lower amounts (respectively), but still in amounts that will provide the same or similar amount of the yeast component (yeast cells) of the yeast ingredient.

According to certain embodiments of the invention, the total amount of the yeast ingredient that will be included in a final dough composition can be added to the preferment composition, meaning that no additional yeast is added to the preferment dough composition, as an additional dough ingredient, after the preferment composition has been rested or fermented. Adding all of a total amount of yeast in a dough formulation to the preferment composition can result in a relatively high amount of carbon dioxide being produced during fermentation of the preferment dough composition, provided there is ample nutrient to metabolize. The high amount of carbon dioxide can result in saturation of the aqueous component of the dough composition with carbon dioxide.

A preferment dough composition should also include some form of yeast nutrient, which is an ingredient that can be metabolized by the yeast to produce a prefermented dough composition. A yeast nutrient can be a nutrient that is useful with a particular yeast, whereby the yeast and its enzymes can metabolize the nutrient to produce metabolites. A yeast nutrient can be included as a constituent of a flour that is included in a preferment composition, or may be added as a separate ingredient such as a sugar. A single example of useful non-flour yeast nutrient is a class of sugars generally known to act as yeast nutrients, including dextrose.

The amount of yeast nutrient included in a preferment dough composition can be any amount that is useful for the amount of yeast, to produce a desired amount of metabolites, as will be understood by a skilled artisan. Examples of useful amounts of non-flour yeast nutrient, such as a sugar, that can be included in a preferment composition can be an amount in the range from 1 to 10 weight percent yeast nutrient based on the total weight of the preferment dough composition, e.g., from 3 to 6 percent by weight based on the total weight of the preferment dough composition.

A preferment dough composition can include liquid water in an amount that, with the other ingredients, will produce a preferment dough composition having useful properties, including useful structure and consistency, i.e., structure and consistency that allow for fermentation of yeast and expansion and retention of bubbles. The amount of water in any particular preferment composition should be an amount that wets out the ingredients and provides a preferment composition having sufficient strength and cohesion to maintain bubbles formed upon evolution of gaseous metabolites such as carbon dioxide, e.g., in a closed cell structure of a dough matrix containing bubbles of carbon dioxide. Exemplary amounts of water in a preferment dough composition can be at least about 30 to 60 weight percent water based on the total weight of the preferment dough composition, e.g., an amount in the range from about 50 to 60 weight percent water based on total weight of the preferment dough composition.

A preferment dough composition according to the invention may also include other optional ingredients including amounts of flavoring, sugar, shortening (oil or plastic), water-binding agent (e.g., hydrocolloid), starch, or additives or preservatives.

Optionally an enzyme such as transglutaminase can be included in a dough composition according to the invention, to further strengthen the dough composition by creating links between proteins in the preferment dough composition matrix. The transglutaminase may be added to the preferment dough composition prior to resting, or later, but can be especially effective if added to the preferment dough composition to interact with protein at an early stage of preparation of a finished dough composition, with additional dough ingredients. Transglutaminase may be included in any amount effective to provide a desired strengthening effect, either to the preferment dough composition or as a later, additional dough ingredient. Exemplary amounts included in a preferment dough composition, or added later, may be, for example, up to 300 parts transglutaminase by weight, per million parts total weight dry ingredients of the finished dough composition.

Optionally, a hydrocolloid may be another ingredient that may be included in a dough composition of the invention, e.g., included as an ingredient of a preferment dough composition or added later to a rested prefermented dough composition. Hydrocolloid may be included to modify the viscosity of a dough matrix, to further provide desired mechanical, rheological, or leavening properties of a preferment dough composition or a finished dough composition. For example, a hydrocolloid may be included in a preferment dough composition in an amount effective to modify the size of bubbles present in the preferment dough composition, as desired, e.g., to produce relatively small bubbles. Examples of useful hydrocolloid materials can include xanthan, guar, locust bean, agar, gellan, propylene glycol alginate, or any other hydrocolloid used or useful in a bread formulation. Such materials may be included in a preferment or a finished dough composition in any desired or useful amounts, which may vary depending on the type of hydrocolloid selected. As an example, guar may be included in a preferment dough composition in amount in the range from 0.01 to 1 weight percent guar based on the total weight of a preferment dough composition; propylene glycol alginate may be included in an amount in the range from 0.01 to 0.1 weight percent propylene glycol alginate based on the total weight of a preferment dough composition.

Also according to the invention, a dough composition (either the preferment or the finished dough composition) can include certain types of starch. According to specific embodiments of the invention, a preferment dough composition or finished dough composition can include a starch that exhibits a relatively low, high-temperature viscosity (a relatively low “hot viscosity”). See, e.g., Applicants' copending United States Patent Application attorney docket number PIL0177US (P6451) entitled “HIGH EXPANSION DOUGH COMPOSITIONS AND METHODS,” filed on even date herewith and incorporated herein by reference in its entirety.

Without being bound by theory, native wheat starch typically found in many varieties of wheat and flour ingredients often used to prepare various dough products, are not always ideal for the performance of certain unproofed dough products, such as freezer-to-oven dough products. According to the invention, therefore, the amount of such native wheat starches normally used in many standard or conventional dough compositions can be replaced with or diluted with a starch that provides better properties for a desired dough composition, such as an unproofed dough composition, e.g., a freezer-to-oven dough composition. As an example, it has been found that starches that exhibit a relatively low viscosity at high temperatures, e.g., temperatures experienced during baking, such as 150° F.-212° F., relative to native wheat starch, can improve baking properties of unproofed doughs. Sources of starch that contain amylopectin exclusively, and modified corn starch, are examples of such types of starch. Amylopectin can be found in certain types of natural wheats or flours prepared from certain natural wheats, including waxy wheat and waxy wheat flour. Amylopectin can also be found in commercial starch materials.

Still wishing to not be bound by theory, starch can affect rheological properties of a dough matrix during cooking, by allowing the dough composition to expand during a cooking (e.g., baking) cycle, up until a point in time during the cycle at which the starch increases in viscosity and the dough matrix changes from an expandable gas discontinuous foam, to a gas continuous sponge. When this occurs, the dough matrix is thereafter inhibited or prevented from expanding further during the remaining portion of the cooking cycle.

Dough compositions of the invention can optionally include a starch that exhibits a relatively low, high-temperature viscosity (“hot viscosity”). The effect of including a starch having the described, relatively low high-temperature viscosity, is to dilute the rheological effects of the standard non native wheat starches normally used in certain types of dough compositions. Specifically, a starch as described herein can exhibit a lower viscosity at high temperature, compared to the native wheat starch in a conventional flour. The lower viscosity at high temperature (e.g., temperatures experienced during baking) can affect the amount of expansion a dough composition experiences during baking. A dough composition can expand upon being baked, during the portion of the baking cycle up until the starch increases in viscosity to a point at which the overall effect of the starch inhibits further expansion of the dough. Thus, starches that maintain a lower viscosity during baking (e.g., a as measured in terms of a “hot-viscosity”), can experience expansion during a greater portion of a baking cycle. During baking up until up until the increasing viscosity of the starch begins to inhibit further expansion of the dough composition, the rheology of the overall dough is sufficiently viscoelastic to allow stretching of the dough matrix and expansion of the dough, as gases within the dough expand due to the increased temperature caused by cooking. The use of a starch that has a relatively low viscosity into a baking cycle, e.g., as measured by “hot viscosity,” allows for an extended portion of a baking cycle during which the dough composition has the ability to expand. Overall, a relatively low “hot viscosity” can result in a greater period of a baking cycle during which expansion of the dough composition can occur, resulting in an overall greater amount of expansion of a dough composition during baking, and consequently a higher baked specific volume.

A starch that exhibits a low viscosity at high temperature can be included in a dough composition, either as an ingredient in a preferment dough composition, or as an ingredient added later, e.g., after resting a preferment dough composition. The starch may be a component of a particular type of flour that includes the starch, or the starch may be included as a separate (non-flour) ingredient, that contains the starch, e.g., a concentrated amount of the starch.

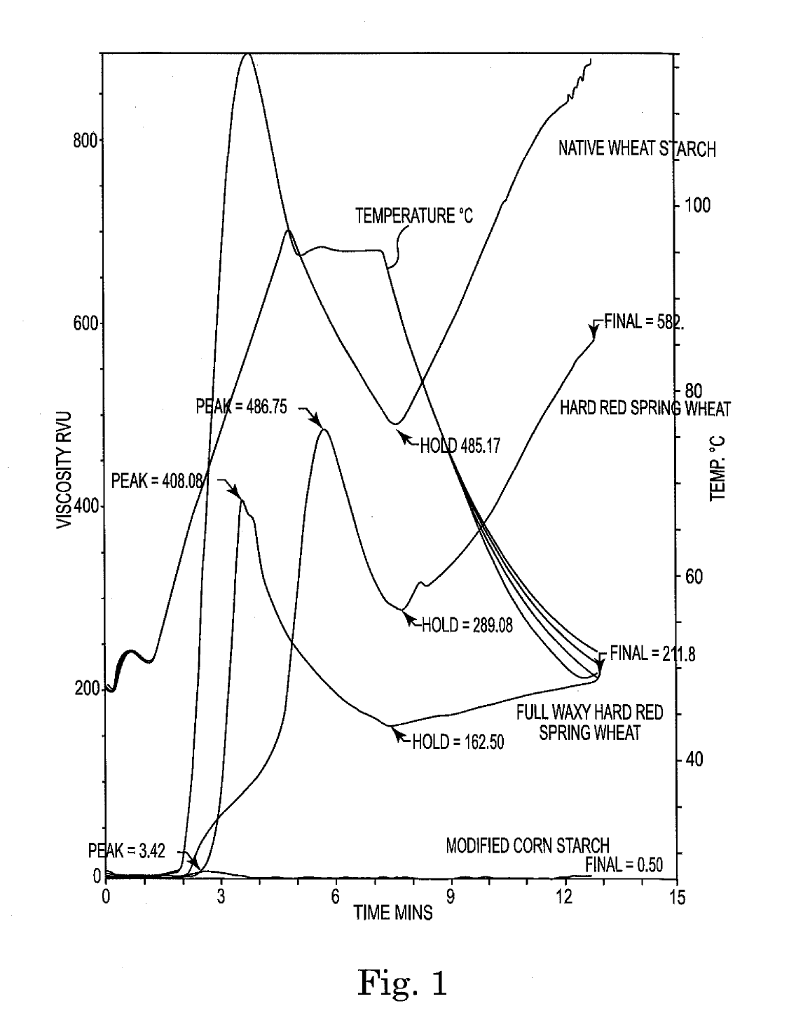

A viscosity of a starch at baking temperature, e.g., a “hot viscosity” can be measured using a Rapid Visco Analyzer (RVA). A Rapid Visco Analyzer is a device commonly used to evaluate the pasting characteristics of flours and starches, including the swelling, gelatinization, disintegration, and gelling abilities. Standard methods to evaluate starch pasting have been developed and adopted as official methods by the American Association of Cereal Chemists (AACC Method 76-21). The testing methods use a metal sample cup in which water and starch are added. A paddle inserted into the sample cup keeps the starch in suspension over a heating profile. This profile typically includes a heating stage, a hold time at the peak temperature, and a cooling profile. See FIG. 1. As the starch slurry is heated, the viscosity changes, and this is measured as a change in torque on the paddle. Generally, as heating begins, there is an initial increase in viscosity when the starch granules swell. Peak viscosity is observed when all of the starch granules have swollen to their greatest extent without losing their integrity. During the hold time at the peak temperature, the granules lose their integrity, a stage known as “pasting.” At this point, viscosity decreases. As the cooling stage begins, amylose and amylopectin found in certain starches may begin to reassociate and thus increase the viscosity of the paste. This increase in viscosity is commonly known as the term “set-back.” Starches with high amylose content will exhibit set-back to a greater degree.

Examples of types of starch that have been found to exhibit a desirably low viscosity at high temperature, include waxy starches (amylopectin), and modified corn starch. An example of a type of flour that includes starch having a low high-temperature viscosity is amylopectin found in waxy wheat flour, e.g., full waxy wheat (hard spring or hard winter) flour. The RVA shows distinct differences in the time where peak viscosity occurs for waxy and standard wheat flours. The peak viscosity in the RVA method outlined above occurs at 3.6 minutes for the waxy wheat and 5.8 minutes for a standard wheat flour. Not only is the peak viscosity lower and occurs earlier for the full waxy wheat flour, but the minimum viscosity after peak, or “trough” occurs at high temperature, where typical wheat flour is at its maximum viscosity. This explains the observation that unproofed frozen doughs made from waxy wheat flours exhibit rapid expansion at the back half of the bake cycle, as opposed to consistent expansion throughout the bake cycle.

Similar observations are made in the comparison of native wheat starch and hydroxypropylated acid-thinned corn starch. The modified corn starch exhibits almost no increase in viscosity during the profile, where the native wheat starch increases dramatically and demonstrates a minimum viscosity of 485 RVA units after peak.

Flours useful to the invention should exhibit peak viscosity at temperatures lower than that of native wheat starch; this would be less than 85° C. These ideal flours would also demonstrate a low viscosity after peak in the RVA test as described over the range of temperatures where native wheat starch exhibits peak viscosity; this would be about 95° C. Pure starches or modified starches would demonstrate similar characteristics as compared with pure native wheat starch.

The term “starch ingredient” refers to a non-wheat-flour dough ingredient that contains starch. While standard wheat-flours include various types of different starches, the term “starch ingredient” is not meant to include standard wheat-flour ingredients such as those that include predominantly native wheat starches, whole wheat flour, or those that include potato starch. Still, according to the present description, reference to the total amount of starch having a relatively low high temperature viscosity will include all such starch in a dough composition, whether added as a non-flour “starch ingredient” or as starch that is included in a dough composition as a component of a wheat flour ingredient (e.g., waxy wheat flour), or as any other ingredient of a dough composition.

Examples of starch ingredients that include starch having a low, high-temperature viscosity can include ingredients known in the dough and bread making arts, such as hydrophobic starches; high amylopectin starch source; waxy wheat flour, especially full waxy wheat flour; modified corn starch (e.g., crosslinked, acid thinned, hydroxypropylated, or acetylated corn starches such as hydroxypropylated corn starch having a mid-to high degree of substitution of 2-4%); amylopectin (e.g., a concentrated amylopectin starch source); and combinations thereof.

Starch, generally, can be included in a dough composition by any mode, for example by being present as a component of any dough ingredient such as a type of wheat flour that includes such a starch, a non-wheat flour that includes such a starch, or any non-flour starch ingredient. Similarly, a starch that exhibits a low high-temperature viscosity may be added to a dough composition of the invention at any useful stage of preparation, such as by combining such a starch (e.g., in the form of a wheat flour or a non-wheat flour starch ingredient) with other ingredients to produce a preferment dough composition, or by combining such a starch (e.g., in the form of a wheat flour or starch ingredient) with a preferment dough composition, as an additional dough ingredient, after the preferment dough composition has been rested. In embodiments of the invention that include a starch that exhibits a relatively low viscosity at high temperature, such starch may be most effective if included in the initial preferment mix or the final dough mix, as opposed to an intermediate mixing step.

When included in a dough composition of the invention, an amount of a starch having a relatively low high temperature viscosity, that can be included in a dough composition of the invention, can be an amount that, in a dough composition having other ingredients and features as described herein, results in desired or improved leavening properties as described. The particular amount of such a starch that is included in any specific dough composition can depend on factors such as the type of dough product, the desired rheology of a dough matrix, desired leavening properties of the dough during processing and cooking, and types and amounts of other dough ingredients. An exemplary range of amounts of starch having a relatively low high temperature viscosity, in a dough composition of the invention, can be in the range up to 30 weight percent of such starch based on the total weight of a dough composition, e.g., from 10 to 15 weight percent of such starch based on the total weight of a dough composition.

A dough composition of the invention can also include other starch that does not have a relatively low high-temperature viscosity. In specific exemplary embodiments, a dough composition can include a total amount of all starch that is from about 0 to 20 percent native wheat starch from wheat flour (having a Peak viscosity of greater than 5000 cP at a peak time of greater than 3.75 minutes and a trough viscosity of at least 3300 cp when measured using AACC method 76-21, which is not considered to be a relatively low high-temperature viscosity), and from about 80 to 100 percent by weight of a starch that does exhibit a relatively low high-temperature viscosity e.g., full waxy wheat flour or hydroxypropylated acid thinned starch (having a Peak viscosity less than 5000 cP at a peak time of less than 3.75 minutes and a trough viscosity less than 2500 cp when measured using AACC method 76-21, which is considered to be a relatively low high-temperature viscosity).

The following table lists exemplary amounts of certain ingredients that may be include in a certain embodiments of preferment dough compositions according to the invention:

INGREDIENT

| | |
|---|---|
| | Weight percent, based on |
| | total weight of the pre- |
| | ferment dough composition |
| Flour (total) | up to 45 |
| Concentrated Protein Ingredient | 6 to 40 |
| Water | 40 to 70 |
| Yeast (compressed) | 2 to 20 |
| Sugar | 0 to 10 |
| | Weight percent of |
| | ingredient, based on |
| | total ingredients above |
| Amount of total starch in preferment dough | 0 to 40 |
| composition having a low “hot viscosity”— | |
| including any amount in a non-flour “starch | |
| ingredient” plus any amount in a flour such | |
| as waxy wheat flour. | |
| Amount of total protein in preferment | 4 to 35 |
| dough composition—including any amount | |
| in a “concentrated protein ingredient,” plus | |
| any amount in a flour ingredient. | |

Ingredients used to prepare a preferment dough composition can be combined in any useful manner that allows the preferment dough composition to be produced and processed to contain bubbles and a dough matrix having good gas-holding capacity and leavening properties. The preferment composition can be prepared and processed to allow protein from a concentrated protein ingredient (e.g., gluten) to become hydrated, and to allow yeast to ferment, e.g., preferment, to produce a preferment dough composition that contains carbon dioxide in the form of bubbles in the matrix, and absorbed in water of the dough composition. The composition can be allowed to ferment by resting or otherwise maintaining the preferment dough composition at conditions effective to cause yeast fermentation, typically while the dough composition is maintained in a stationary and still position. Temperatures that can be useful to rest the preferment dough composition can be in the range from about 45 to 95 F., e.g., from about 60 to about 80 F. In some embodiments, the preferment dough composition can be left at room temperature for a time in the range from 15 minutes to 2 hours.

A goal of fermenting the dough composition can be to produce a preferment dough composition with a high concentration of carbon dioxide, including gaseous carbon dioxide and carbon dioxide dissolved in water, and a developed dough matrix that will exhibit high viscoelasticity and therefore increase the number of bubbles retained during mixing in additional ingredients to product a finished dough composition. Additional ingredients are subsequently added to the rested preferment dough composition, and the combined ingredients are processed to produce a final or finished dough composition. According to the invention, bubbles and carbon dioxide present in the preferment dough composition are transferred to the final dough. The carbon dioxide and bubbles later contribute to expansion of the dough composition during baking and increase the baked specific volume of the baked dough product.

Thus, a dough composition according to the invention can be prepared by combining a prefermented dough composition that contains a concentrated protein ingredient as described herein, with additional dough ingredients, to produce a final dough composition that contains many ingredients known in the dough and bread-making arts, typically including flour, yeast, a liquid component such as oil or water, and optionally additional ingredients such as shortening, salt, sweeteners, dairy products, egg products, processing aids, emulsifiers, particulates, dough conditioners, flavorants, etc.

A final dough composition may include, for example, flour in an amount between about 10 percent to about 40 percent by weight flour based on the total weight of the dough composition e.g., from 20 to 30 weight percent flour; water in an amount between 25 and about 50 percent by weight of the total dough composition, e.g., from 30 to 40 weight percent water; sugar or another sweetener in an amount in a range of between 1 and about 1 percent by weight of the total dough composition, e.g., from 2 to 5 weight percent; and fat (shortening or oil) in a range from 0 and 6 percent by weight of the total dough composition, e.g., from 3 to 5 weight percent fat. Other ingredients such as flavorings, salt, and additives and preservatives can also be included as will be understood.

As discussed above, specific embodiments of final dough compositions of the invention can include other ingredients to improve mechanical or leavening properties, such as transglutaminase, hydrocolloid, and starch having a low high-temperature viscosity. Such a starch allows for an extended period of dough expansion by maintaining a reduced viscosity of a starch in a dough composition at baking temperature, to allow the dough matrix to flow and thereby allow the overall dough composition to continue expanding (relatively longer than if the dough included a starch having a relatively higher “hot viscosity.” According to such embodiments, the production of carbon dioxide in the described form and amounts in a preferment dough composition, that contains a concentrated protein ingredient, in combination with the presence of a starch having a low “hot viscosity,” can provide useful or relatively improved leavening properties of the overall dough composition, such as the ability to be cooked (e.g., baked) without proofing, to a specific volume that is comparable to a specific volume of a baked dough that is similar in nature and that has been processed by proofing.

Thus, additional dough ingredients can be combined with the prefermented sponge, to provide a dough composition having the described ingredients including water; flour; yeast; concentrated protein ingredient; starch or starch having a relatively low high-gelatinization temperature viscosity, or a flour that contains either type of these starches; transglutaminase; hydrocolloid; etc.; as well as other ingredients that will be appreciated. The amounts of the additional dough ingredients that are combined with the preferment dough composition, can be amounts that will result in a dough composition that includes amounts of ingredients described herein, and that will result in a final dough composition that exhibits useful leavening properties, e.g., as described.

Examples of total amounts of ingredients in a dough composition of the invention, can be as follows:

### Exemplary Ingredients in Dough Composition

INGREDIENT

| | |
|---|---|
| | Weight percent, based |
| | on total weight dough |
| | composition |
| Flour (total) | 10 to 55 |
| Starch ingredient, including starch having a | 0 to 30 |
| relatively low high-temperature viscosity | |
| Concentrated protein ingredient | 3 to 20 |
| Water | 25 to 50 |
| Yeast (compressed) | 1 to 6 |
| Sugar | 1 to 12 |
| Transglutaminase | 0 to 300 ppm |
| Hydrocolloid | 0 to 4 |
| | Amount of ingredients, |
| | based on total |
| | ingredients above |
| Amount of starch in finished dough | 0-25 |
| composition having a relatively low high- | |
| temperature viscosity—including any | |
| amount in a non-flour “starch ingredient” | |
| plus any amount in a flour such as waxy | |
| wheat flour. | |
| Amount of total protein in a finished dough | 7 to 30 |
| composition—including any amount in a | |
| “concentrated protein ingredient,” plus any | |
| amount in a flour ingredient | |

Dough compositions of the invention can be types of dough compositions that are typically prepared using a “preferment” method. Examples include developed doughs such as those that include bread doughs such as bread loaves or rolls, croissants, pizza crusts, bagels, pretzels, and the like. Advantageously, doughs of the invention can be prepared into an unproofed dough (e.g., having a raw specific volume in the range from 0.9 to 1.1 cubic centimeters per gram), and baked directly from the unproofed state without a proofing step or a partial proofing step, and without partial baking. The unproofed dough may be stored at refrigerated or frozen conditions, and baked without proofing, optionally without thawing for a frozen dough, to a useful baked specific volume that may be comparable to similar doughs that require any one or more of proofing, partial proofing, or partial baking. Examples of amounts of certain ingredients useful to produce such doughs, in terms of preferment dough and final dough compositions, include ingredients listed in the following table (these amounts are not exclusive of other ingredients):

| | Preferment | | Total Dough Compositions | |
|---|---|---|---|---|
| | Useful | Specific | Useful | Specific |
| Water | 40-80% | 60-70% | 28-50% | 33-39% |
| Yeast (compressed) | 2-20% | 8-12% | 1-6% | 2.5-4.5% |
| Yeast food | 1-10% | 3-6% | 1-12% | 2.5-4.5% |
| Flour | 2-45% | 10-40% | 10-55% | 20-30% |
| Gluten ingredient | 6-40% | 15-25% | 3-20% | 8-12% |
| Starch Ingredient | 0% | 0% | 0-30% | 10-15% |
| containing starch having a | | | | |
| low “hot viscosity” | | | | |
| Transglutaminase | 0-300 ppm | 50-100 ppm | 0-300 ppm | 50-100 ppm |
| | flour basis | flour basis | flour basis | flour basis |
| Hydrocolloid | 0-2% | 0.5-1.0% | 0-4% | 1-2% |
| Fat (shortening or oil) | 0% | 0% | 0-6% | 3-5% |
| Salt | 0% | 0% | 0-2% | 1-1.5% |
| Emulsifiers (SSL, | 0% | 0% | 0-0.8% | 0.3-0.5% |
| DATEM, etc.) | | | | |
| Oxidant (ascorbic acid) | | | 0-0.01% | .0025-0.075% |
| Total protein (calculated as | 4-33% | 12-21% | 3-30% | 7-13% |
| protein contained in flour | | | | |
| and any concentrated | | | | |
| protein ingredient) | | | | |
| Total amount starch having | 0 to 40% | 0 to 40% | 0 to 30% | 3 to 25% |
| a low “hot-viscosity” | | | | |
| (calculated as starch | | | | |
| contained in a starch | | | | |
| “ingredient” (if any) plus | | | | |
| starch present in flour | | | | |

Optionally, specific embodiments of the dough compositions of the invention can be leavened without the assistance of a chemical leavening system, which means chemical ingredients such as an acid and base that must contact each other and produce a chemical reaction to produce a leavening gas, generally carbon dioxide, which causes a dough to expand. Instead, dough compositions of the invention can be leavened during cooking (e.g., baking) based on the presence of carbon dioxide bubbles, absorbed carbon dioxide, water vapor, etc., that is present in the dough during baking based on the fermentation of the sponge. Because of the strengthened dough composition resulting from the concentrated protein ingredient, and optionally the use of a starch having a relatively low high-temperature viscosity starch, a dough of the invention can expand from a frozen state during baking to a finished baked volume that may be 3.5, 4, or 4.5 times the original unproofed volume. In still other embodiments, a dough of the invention can be stored frozen, placed in a retarder or refrigerator for thawing (e.g., at 40 to 45F.), and baked without proofing to a volume that is up to or in excess of 4.5 or 5.5 times the original unproofed volume.

The actual baked specific volume of any particular dough product of the invention can depend on the type of dough product, the use of selected processing steps as described herein, relative amounts of ingredients, and the exact dough formulation. Exemplary baked specific volumes of dough product prepared according to the invention, can be at least about 4 cc per gram, e.g., at least about 4.5 cc per gram, even up to or in excess of 5.5 cc per gram. The baked specific volume of a baked dough product will depend greatly on the composition of the dough composition and the type of dough product it is composed to produce, e.g., a bread loaf, a roll, a sweet roll, a pizza crust, Danish, etc.

Thus, such dough compositions can be baked to baked specific volumes that are typical and conventional in the baking industry of useful yeast-leavened dough products, including baked specific volumes of pre-proofed or thawed-and-proofed yeast-leavened dough products. But, because the dough compositions of the invention do not require a proofing step, the doughs can be useful as unproofed freezer-to-oven doughs, as unproofed thaw-and-bake (e.g., retarder-to-oven) dough compositions, or as dough compositions that can be directly cooked (e.g., baked) following preparation, without the need for a proofing step or partial baking step, and optionally without the need for chemical leavening agents.

1-12. (canceled)

13. A method of preparing a dough composition, the method comprising
preparing a high-gluten preferment dough composition comprising
water,
yeast,
yeast food, and
concentrated protein ingredient;
resting the preferment dough composition, and
combining the preferment dough composition with additional dough ingredients comprising
flour, and
additional water; and
freezing the dough composition at a raw specific volume in the range from 0.9 to 1.5 cubic centimeters per gram.

14. The method of claim composition of claim 13 wherein
the dough composition contains no chemical leavening agent, and
the additional dough ingredients contain no concentrated protein ingredient.

15. The method of claim 13 wherein the additional dough ingredients contain no yeast ingredient.

16. The method of claim 13 comprising resting the preferment dough composition for a time in the range from 15 to 120 minutes, before combining the preferment dough composition with additional dough ingredients.

17. (canceled)

18. The method of claim 17 comprising baking the dough composition to a baked specific volume in the range from 3 to 10 cubic centimeters per gram.

19-22. (canceled)

23. The method of claim 13 wherein the preferment dough composition comprises from 3 to 40 weight percent concentrated gluten ingredient.

24. The method of claim 13 comprising baking the dough composition, without proofing, to a baked specific volume that is increased relative to a baked specific volume of a dough composition that contains the same ingredients but is prepared by adding the concentrated protein ingredient after the resting step.

25. The method of claim 13 wherein the preferment dough composition comprises
from 40 to 80 weight percent water,
from 8 to 12 weight percent compressed yeast ingredient,
from 1 to 10 weight percent sugar,
from 2 to 20 weight percent flour, and
from 15 to 25 weight percent concentrated gluten ingredient.

26. The method of claim 13 wherein the preferment dough composition comprises
from 40 to 80 percent water,
yeast in an amount provided by 2 to 20 percent compressed yeast ingredient,
flour in an amount up to 40 weight percent,
yeast food, and
from 15 to 40 weight percent concentrated protein ingredient;
wherein the total amount of protein in the preferment dough is in the range from 4 to 35 weight percent based on total weight preferment dough composition.

27. The method of claim 13 wherein the total amount of protein in the preferment dough composition is in the range from 12 to 35 weight percent based on total weight preferment dough composition.

28. The dough composition of claim 13 wherein the preferment composition comprises from 15 to 40 weight percent concentrated gluten ingredient and from 7 to 30 weight percent total protein.

29. A method of preparing a dough composition, the method comprising
preparing a high-gluten preferment dough composition comprising
from 40 to 80 percent water,
yeast,
yeast food, and
from 15 to 40 weight percent concentrated protein ingredient;
resting the preferment dough composition for a time in the range from 15 to 120 minutes, and
combining the rested preferment dough composition with additional dough ingredients comprising
flour, and
additional water.
freezing the dough composition, at a raw specific volume in the range from 0.9 to 1.5 cubic centimeters per gram.

30. The method of claim 29 wherein the total amount of protein in the preferment dough composition is in the range from 12 to 35 weight percent based on total weight preferment dough composition.

31. The method of claim 29 wherein the preferment composition comprises from 15 to 40 weight percent concentrated gluten ingredient and from 7 to 30 weight percent total protein.

32. The method of claim 13 comprising freezing the dough composition, at a raw specific volume in the range from 0.9 to 1.1 cubic centimeters per gram.

33. The method of claim 13 comprising baking the frozen dough composition, without thawing or proofing.

34. The method of claim 13 wherein the frozen dough is capable of being baked from frozen, without proofing, to a baked specific volume of at least 3 cubic centimeters per gram.

35. The method of claim 29 comprising freezing the dough composition, at a raw specific volume in the range from 0.9 to 1.1 cubic centimeters per gram.

36. The method of claim 29 comprising baking the frozen dough composition without thawing or proofing to a baked specific volume in the range from 3 to 10 cubic centimeters per gram.

37. The method of claim 29 wherein the frozen dough is capable of being baked from frozen, without proofing, to a baked specific volume of at least 3 cubic centimeters per gram.

38. A method of preparing a baked dough product, the method comprising:
providing a frozen dough composition prepared according to the method of claim 13, and
baking the dough from without thawing or proofing.

39. A method of preparing a baked dough product, the method comprising:
providing a frozen dough composition prepared according to the method of claim 29, and
baking the dough from without thawing or proofing.
